(19) United States
(12) Patent Application Publication
(10) Pub. No.: US 2017/0270668 A1
(43) Pub. Date: Sep. 21, 2017

(54) Discrete Edge Binning Template Matching System, Method And Computer Readable Medium

(71) Applicant: Fio Corporation, Toronto (CA)

(72) Inventor: Graham Greenland, Toronto (CA)

(21) Appl. No.: 15/310,049

(22) PCT Filed: May 11, 2015
(86) PCT No.: PCT/CA2015/000302

§ 371 Date: Nov. 9, 2016

Related U.S. Application Data
(60) Provisional application No. 61/991,419, filed on May 9, 2014.

(51) Int. Cl. G06T 7/00; G06T 7/13

(52) U.S. Cl. CPC G06T 7/0014; G06T 7/13

(57) ABSTRACT

According to the invention, one or more discrete edge binning (“DEB”) features of a DEB template matching system, method and/or computer readable medium may preferably comprise and/or apply an image processing algorithm, preferably for use in template matching. According to the invention, template matching may preferably involve using one or more known reference features to detect and/or localize similar features within an image.

### CROSS REFERENCE TO RELATED APPLICATIONS

This application is a U.S. National Stage of International Application No. PCT/CA2015/000302, filed May 11, 2015, which claims the benefit of priority of U.S. Provisional Patent Application No. 61/991,419, filed May 9, 2014, each of which are hereby incorporated by reference in their entirety.

### FIELD OF THE INVENTION

The present invention relates generally to the field of template matching, and more particularly to a system, method and computer readable medium for template matching images using discrete edge binning.

### BACKGROUND OF THE INVENTION

In the field of image recognition, the ability to accurately capture the appearance of specific features may be used to convey information. For example, in the medical diagnostics industry, it may be desirable to provide for the recognition of rapid diagnostic tests (“RDTs”) based on their appearance. The correct identification and/or localization of RDT specific features within an image, preferably with a high degree of accuracy and/or with high sensitivity and/or specificity, may be desirable as it may facilitate, among other things, the diagnosis of a disease state, the presence or absence of a biomarker and/or the presence or absence of environmental agents.

As may be appreciated by persons having ordinary skill in the art, some of the challenges of accurate image recognition may arise from the features comprising an image being highly variable, perhaps due to variability in manufacturing tolerance (e.g., variability in the manufacturing of an RDT cassette, which may affect its position during image capture), lighting (e.g., variability in ambient lighting during image capture may affect image contrast), and/or feature state. Variations in feature state may have been particularly problematic in prior art RDT image recognition as the variation may be due to significant changes in a feature between images. For example, in some instances, it may be critical and/or preferable to be able to detect a feature regardless of the feature's state. If a membrane of an RDT is solid white in one image and/or covered in blood and/or test lines in another image, it may be difficult to match the feature's state with accuracy, sensitivity and/or specificity.

As may be known to persons having ordinary skill in the art, a state of a feature may present two design constraints and/or preferences which may be desirable. A first design constraint and/or preference may be contrast invariance of feature edges. For example, if blood is present in one image and not another, the contrast of adjacent edges may be highly variable. A second constraint and/or preference may be regional invariance. For example, if the manufacturing tolerance of one cassette differs from another, the region of the cassette captured for template matching may be highly variable. Accordingly, one or more aspects of a problem associated with image recognition devices, systems, methods and/or computer readable media in the prior art may have included the following limitations: localizing image features with high sensitivity and specificity; contrast invariance; and/or selectable regional invariance. Therefore, it may be desirable to provide an algorithm as part of and/or for use in association with a system, method and/or computer readable medium which may intrinsically allow for the designation of regions which may be ignored by other algorithms.

Template matching may be a well-established fundamental approach to localize objects within an image [see, for example, W. K. Pratt, “Digital Image Processing, 3^{rd} Ed”, John Wiley & Sons, Inc., New York, 2001, pgs 613-625]. As may be appreciated by persons having ordinary skill in the art, template matching may have been used, more or less extensively, in computer vision applications, such as facial recognition, medical image processing, and/or image registration. Perhaps in its simplest form, template matching may be performed by taking a sub-image, and sliding it across an entire image, preferably while calculating one or more types of scoring functions (e.g., absolute difference, cross-correlation, etc.). The areas of the image that return the highest score(s) may be considered as possible matches.

In practice, persons having ordinary skill in the art may appreciate that image features may possess one or more complicating factors which may impact performance, possibly including one or more of the following: noise (e.g., a random variation of brightness or colour information in images); affine transformations (e.g., translation, rotation); lighting difference (e.g., contrast); feature variability; and/or other distortions.

Many prior art template matching approaches may have been presented to deal with one or more of these and/or other limitations, potentially including attempts at contrast invariance. One or more attempts at contrast invariance may have applied one or more localized transformations to image data, preferably to normalize contrast across the image. This approach may have been less than ideal in some situations (e.g., where a range of contrast may be very large and/or unpredictable). Additionally and/or instead, template matching in general may not have allowed definition of areas that may be regionally invariant.

Persons having ordinary skill in the art may have previously failed to consider using approaches for image registration to address regional invariance. These approaches may have extracted and/or matched specific features in (and may be invariant to) surrounding regions. Popular approaches—such as the scale-invariant feature transform (“SIFT”) algorithm [see, for example, D. Lowe, “Method and apparatus for identifying scale invariant features in an image and use of same for locating an object in an image”, U.S. Pat. No. 6,711,293] or histogram of oriented gradients (“HOG”) technique [see, for example, N. Dalal, “Histograms of Orientated Gradients for Human Detection”, Computer Vision and Pattern Recognition, 2005. CVPR 2005. IEEE Computer Society Conference, June 2005]—may have extracted feature descriptors from an image, which then may have been compared to a set of known descriptors. One or both of the aforementioned techniques also may have used a histogram of orientation approach [see, for example, W. T. Freeman and M. Roth, “Orientation histograms for hand gesture recognition”, Intl. Workshop on Automatic Face and Gesture—Recognition, IEEE Computer Society, Zurich, Switzerland, pages 296-301, June 1995], which may have been shown to offer high accuracy in feature detection. These approaches may have created histograms from surrounding pixels in order to define a cell and/or block, which may have been used for matching. One of the limitations of this prior art approach may have been that they generally may have been limited in the size of the feature that can be defined. Potentially problematically, in some applications, the feature size may be large and/or quite variable.

Even in view of the above prior art approaches, persons having ordinary skill in the art may have previously failed to define a template as a group of cells, though it may be desirable to do so. Such a group of cells may preferably be defined as only those features which are desired for matching, preferably allowing and/or facilitating selective exclusion of areas with high variability, and/or preferably to provide selectable regional invariance.

What may be needed is a system, method, and/or computer readable medium that overcomes one or more of the limitations associated with the prior art. It may be advantageous to provide a system, method and/or computer readable medium that preferably facilitates image template matching and/or enables the correct identification and/or localization of RDT specific features within an image. There may also be some advantage to providing a system, method and/or computer readable medium that preferably provides for template matching, as well as the identification and/or localization of specific features in an image, with a high degree of accuracy and/or with high sensitivity and/or specificity.

It may be an object of one preferred embodiment according to the invention to identify and/or localize a feature on an image.

It may be an object of one preferred embodiment according to the invention to compare a feature of an image with a reference feature.

It may be an object of one preferred embodiment according to the invention to identify and/or localize a feature on an image of an RDT cassette with a variability in manufacturing tolerance.

It may be an object of one preferred embodiment according to the invention to identify and/or localize a variable feature state on an image.

It may be an object of one preferred embodiment according to the invention to identify and/or localize a feature on an image with low contrast, significant noise, affine transformations, and/or lighting differences.

It may be an object of one preferred embodiment according to the invention for extracting features from an image.

It may be an object of one preferred embodiment according to the invention to for classifying extracted features from an image.

It may be an object of one preferred embodiment according to the invention to detect an edge from an image.

It may be an object of one preferred embodiment according to the invention to perform orientation and/or spatial binning of pixels comprising an image.

It may be an object of one preferred embodiment according to the invention to produce an image that has been transformed by scaling, low pass filter, grayscale conversion, differentiation, and/or edge definition and threshold determination.

It may be an object of the present invention to obviate or mitigate one or more disadvantages and/or shortcomings associated with the prior art, to meet or provide for one or more needs and/or advantages, and/or to achieve one or more objects of the invention—one or more of which may preferably be readily appreciable by and/or suggested to those skilled in the art in view of the teachings and/or disclosures hereof.

### SUMMARY OF THE INVENTION

According to the invention, there is disclosed a method of matching at least part of an image against one or more reference templates stored in a database. At least one edge feature is embedded in the image. The method includes a database providing step of providing the database, such that each of the reference templates comprises a set of reference feature parameters. The method also includes a receiving step of receiving the image. The method also includes a feature extraction step. The feature extraction step includes a differential edge detection substep of using a contrast invariant technique to render the image contrast invariant and/or to depict one or more edge pixels of the edge feature among one or more image pixels of the image. The feature extraction step also includes an orientation and/or spatial binning substep of binning the edge pixels into a predetermined number of orientation bins, and/or spatially binning adjacent ones of the image pixels into discrete edge binning (DEB) cells, to generate a DEB cell image depicting the edge feature. The method also includes a feature classification step. The feature classification step includes a feature response substep of comparing the DEB cell image to each aforesaid set of reference feature parameters to determine how well the DEB cell image matches each of the reference templates. The feature classification step also includes a match detection substep of locating a best match of the DEB cell image among the reference templates, and/or correlating the best match against one or more predetermined match threshold values to determine when a matching one of the reference templates is found. In this manner, according to the invention, the image is matched with the matching one of the reference templates.

According to an aspect of one preferred embodiment of the invention, a first one of the reference templates may preferably, but need not necessarily, be provided with higher sensitivity, than a second one of the reference templates, to the edge feature embedded in the image and/or depicted in the DEB cell image.

According to an aspect of one preferred embodiment of the invention, preferably in the differential edge detection substep, the image may preferably, but need not necessarily, be scaled and/or any artifacts in the image with spatial resolution lower than a predetermined spatial resolution threshold value may preferably, but need not necessarily, be suppressed.

According to an aspect of one preferred embodiment of the invention, preferably in the differential edge detection substep, a low pass filter may preferably, but need not necessarily, be applied to and/or convolved with the image to suppress high frequencies which may be associated with pixel noise.

According to an aspect of one preferred embodiment of the invention, preferably in the differential edge detection substep, the image may preferably, but need not necessarily, be converted to greyscale.

According to an aspect of one preferred embodiment of the invention, preferably in the differential edge detection substep, one or more derivatives of the image may preferably, but need not necessarily, be differentially calculated and/or used to localize and/or geometrically define the edge feature.

According to an aspect of one preferred embodiment of the invention, preferably in the differential edge detection substep, the derivatives may preferably, but need not necessarily, include a gradient calculated by differentiating the image in two dimensions. A direction of the gradient may preferably, but need not necessarily, be obtained and/or used to localize and/or geometrically define the edge pixels of the edge feature at a gradient maximum along the direction of the gradient.

According to an aspect of one preferred embodiment of the invention, the derivatives may preferably, but need not necessarily, be used—preferably with reference to a predetermined edge minimum threshold value—to define the edge feature.

According to an aspect of one preferred embodiment of the invention, preferably in the differential edge detection substep, one or more derivatives of the image may preferably, but need not necessarily, be differentially calculated. The derivatives may preferably, but need not necessarily, be used to calculate an orientation for each of the edge pixels.

According to an aspect of one preferred embodiment of the invention, preferably in the orientation and/or spatial binning substep, the orientation for each of the edge pixels may preferably, but need not necessarily, be assigned to one of the predetermined number of orientation bins most closely corresponding to the orientation.

According to an aspect of one preferred embodiment of the invention, preferably in the orientation and/or spatial binning substep, preferably for each one of the discrete edge binning (DEB) cells, a sum may preferably, but need not necessarily, be calculated based on the orientation bin assigned to each of the edge pixels among the image pixels spatially binned into the aforesaid each one of the discrete edge binning (DEB) cells.

According to an aspect of one preferred embodiment of the invention, preferably in the orientation and/or spatial binning substep, preferably for each one of the discrete edge binning (DEB) cells, a sum may preferably, but need not necessarily, be calculated based on the orientation for each of the edge pixels among the image pixels spatially binned into the aforesaid each one of the discrete edge binning (DEB) cells.

According to an aspect of one preferred embodiment of the invention, preferably in the orientation and/or spatial binning substep, each of the discrete edge binning (DEB) cells may preferably, but need not necessarily, correlate to a substantially rectangular (M₁×M₂) configuration of the aforesaid adjacent ones of the image pixels.

According to an aspect of one preferred embodiment of the invention, preferably in the orientation and/or spatial binning substep, the image may preferably, but need not necessarily, be processed to generate a cell offset image containing (M₁×M₂) scaled images corresponding to a starting offset of the aforesaid each of the discrete edge binning (DEB) cells.

According to an aspect of one preferred embodiment of the invention, the feature extraction step may preferably, but need not necessarily, also include a feature cropping substep of cropping the DEB cell image to normalize depiction of the edge feature in the DEB cell image.

According to an aspect of one preferred embodiment of the invention, preferably in the feature response substep, preferably for each of the reference templates, a match value may preferably, but need not necessarily, be calculated against the DEB cell image.

According to an aspect of one preferred embodiment of the invention, preferably in the feature response substep, one or more feature response maps may preferably, but need not necessarily, be generated representing how well the DEB cell image matches each of the reference templates.

According to an aspect of one preferred embodiment of the invention, preferably in the match detection substep, the best match may preferably, but need not necessarily, be located on the feature response maps.

According to an aspect of one preferred embodiment of the invention, the method may preferably, but need not necessarily, be adapted for use with a rapid diagnostic test device and/or cassette image as the image.

According to the invention, there is also disclosed a system for matching at least part of an image. At least one edge feature is embedded in the image. The system includes a database which stores one or more reference templates. Each of the reference templates includes a set of reference feature parameters. The system also includes an image receiving element which is operative to receive the image. The system also includes one or more image processors which are operative to match the aforesaid at least part of the image against the reference templates stored in the database. The image processors are operatively encoded to use a contrast invariant technique to render the image contrast invariant and/or depict one or more edge pixels of the edge feature among one or more image pixels of the image. The image processors are also operatively encoded to bin the edge pixels into a predetermined number of orientation bins, and/or spatially bin adjacent ones of the image pixels into discrete edge binning (DEB) cells, to generate a DEB cell image depicting the edge feature. The image processors are also operatively encoded to compare the DEB cell image to each aforesaid set of reference feature parameters to determine how well the DEB cell image matches each of the reference templates. The image processors are also operatively encoded to locate a best match of the DEB cell image among the reference templates, and/or correlate the best match against one or more predetermined match threshold values to determine when a matching one of the reference templates is found. Thus, according to the invention, the system matches the image with the matching one of the reference templates.

According to an aspect of one preferred embodiment of the invention, a first one of the reference templates may preferably, but need not necessarily, have higher sensitivity, than a second one of the reference templates, to the edge feature embedded in the image and/or depicted in the DEB cell image.

According to an aspect of one preferred embodiment of the invention, a first one of the reference templates may preferably, but need not necessarily, match a different region of the image than a second one of the reference templates.

According to an aspect of one preferred embodiment of the invention, the image processors also may preferably, but need not necessarily, be operatively encoded to scale the image and/or suppress any artifacts in the image with spatial resolution lower than a predetermined spatial resolution threshold value.

According to an aspect of one preferred embodiment of the invention, the system also may preferably, but need not necessarily, include a low pass filter. The image processors also may preferably, but need not necessarily, be operatively encoded to apply the low pass filter to, and/or convolve the low pass filter with, the image to suppress high frequencies which may be associated with pixel noise.

According to an aspect of one preferred embodiment of the invention, the low pass filter may preferably, but need not necessarily, be a multivariate Gaussian filter.

According to an aspect of one preferred embodiment of the invention, the image processors also may preferably, but need not necessarily, be operatively encoded to convert the image to greyscale.

According to an aspect of one preferred embodiment of the invention, the image processors also may preferably, but need not necessarily, be operatively encoded to differentially calculate one or more derivatives of the image and/or to use the derivatives to localize and/or geometrically define the edge feature.

According to an aspect of one preferred embodiment of the invention, the image processors also may preferably, but need not necessarily, be operatively encoded: to calculate one or more of the derivatives as a gradient preferably, but not necessarily, by differentiating the image in two dimensions; to obtain a direction of the gradient; and/or to use the direction of the gradient to localize and/or geometrically define the edge pixels of the edge feature at a gradient maximum along the direction of the gradient.

According to an aspect of one preferred embodiment of the invention, the image processors also may preferably, but need not necessarily, be operatively encoded to use the derivatives—preferably with reference to a predetermined edge minimum threshold value—to define the edge feature.

According to an aspect of one preferred embodiment of the invention, the image processors also may preferably, but need not necessarily, be operatively encoded: to differentially calculate one or more derivatives of the image; and/or to use the derivatives to calculate an orientation for each of the edge pixels.

According to an aspect of one preferred embodiment of the invention, the image processors also may preferably, but need not necessarily, be operatively encoded to assign the orientation for each of the edge pixels to one of the predetermined number of orientation bins most closely corresponding to the orientation.

According to an aspect of one preferred embodiment of the invention, the image processors also may preferably, but need not necessarily, be operatively encoded to, preferably for each one of the discrete edge binning (DEB) cells, calculate a sum based on the orientation bin assigned to each of the edge pixels among the image pixels spatially binned into the aforesaid each one of the discrete edge binning (DEB) cells.

According to an aspect of one preferred embodiment of the invention, the image processors also may preferably, but need not necessarily, be operatively encoded to, preferably for each one of the discrete edge binning (DEB) cells, calculate a sum based on the orientation for each of the edge pixels among the image pixels spatially binned into the aforesaid each one of the discrete edge binning (DEB) cells.

According to an aspect of one preferred embodiment of the invention, the image processors also may preferably, but need not necessarily, be operatively encoded to correlate each of the discrete edge binning (DEB) cells to a substantially rectangular (M₁×M₂) configuration of the aforesaid adjacent ones of the image pixels.

According to an aspect of one preferred embodiment of the invention, the image processors also may preferably, but need not necessarily, be operatively encoded to process the image to generate a cell offset image containing (M₁×M₂) scaled images corresponding to a starting offset of the aforesaid each of the discrete edge binning (DEB) cells.

According to an aspect of one preferred embodiment of the invention, the image processors also may preferably, but need not necessarily, be operatively encoded to crop the DEB cell image to normalize depiction of the edge feature in the DEB cell image.

According to an aspect of one preferred embodiment of the invention, the image processors also may preferably, but need not necessarily, be operatively encoded to, preferably for each of the reference templates, calculate a match value against the DEB cell image.

According to an aspect of one preferred embodiment of the invention, the image processors also may preferably, but need not necessarily, be operatively encoded to generate one or more feature response maps representing how well the DEB cell image matches each of the reference templates.

According to an aspect of one preferred embodiment of the invention, the image processors also may preferably, but need not necessarily, be operatively encoded to locate the best match on the feature response maps.

According to an aspect of one preferred embodiment of the invention, the predetermined match threshold values may preferably, but need not necessarily, include: a predetermined correlation threshold value which may preferably, but need not necessarily, be based on a correlation with the edge feature; and/or a predetermined distance threshold value which may preferably, but need not necessarily, be based on a distance from a search origin for the edge feature.

According to an aspect of one preferred embodiment of the invention, the system may preferably, but need not necessarily, be adapted for use with a rapid diagnostic test device and/or cassette image as the image.

According to the invention, there is also disclosed a computer readable medium for use with an image wherein at least one edge feature is embedded. The computer readable medium is also for use with a database which stores one or more reference templates that each comprise a set of reference feature parameters. The computer readable medium is encoded with executable instructions to, when executed, encode one or more image processors to automatically match at least part of the image against the reference templates stored in the database by automatically performing the steps of: (a) using a contrast invariant technique to render the image contrast invariant and/or depict one or more edge pixels of the edge feature among one or more image pixels of the image; (b) binning the edge pixels into a predetermined number of orientation bins, and/or spatially binning adjacent ones of the image pixels into discrete edge binning (DEB) cells, to generate a DEB cell image depicting the edge feature; (c) comparing the DEB cell image to each said set of reference feature parameters to determine how well the DEB cell image matches each of the reference templates; and/or (d) locating a best match of the DEB cell image among the reference templates, and/or correlating the best match against one or more predetermined match threshold values to determine when a matching one of the reference templates is found. Thus, according to the invention, the computer readable medium encodes the image processors to match the image with the matching one of the reference templates.

Other advantages, features and characteristics of the present invention, as well as methods of operation and functions of the related elements of the system, method and computer readable medium will become more apparent upon consideration of the following detailed description and the appended claims with reference to the accompanying drawings, the latter of which are briefly described hereinbelow.

### BRIEF DESCRIPTION OF THE DRAWINGS

The novel features which are believed to be characteristic of the system, method and computer readable medium according to the present invention, as to their structure, organization, use, and method of operation, together with further objectives and advantages thereof, will be better understood from the following drawings in which presently preferred embodiments of the invention will now be illustrated by way of example. It is expressly understood, however, that the drawings are for the purpose of illustration and description only, and are not intended as a definition of the limits of the invention. In the accompanying drawings:

FIG. 1 is a flow chart of a DEB feature extraction method according to a preferred embodiment of the invention.

FIG. 2 is a flow chart of a DEB feature classification method according to a preferred embodiment of the invention.

FIG. 3 is a flow chart of a differential edge detector step for the method shown in FIG. 1.

FIG. 4a is an illustration of an image using a prior art Sobel edge detector.

FIG. 4b is an illustration of an image using a differential edge technique.

FIG. 5a is an enlarged view of the illustration of FIG. 4b with high contrast.

FIG. 5b is an enlarged view of the illustration of FIG. 4b with low contrast.

FIG. 5c is an enlarged view of the illustration of FIG. 4a with high contrast.

FIG. 5d is an enlarged view of the illustration of FIG. 4a with low contrast.

FIG. 6 is a flow chart of an orientation and spatial binning step for the method shown in FIG. 1.

FIG. 7 is a schematic diagram of the spatial binning substep according to the orientation and spatial binning step of FIG. 6.

FIG. 8 is an illustration of a DEB cell offset image for 4×4 spatial binning according to the spatial binning substep of FIG. 6.

FIG. 9a is an illustration of an original response image R(x,y) according to the feature response step of FIG. 2.

FIG. 9b is an illustration of a reorganized match response image M(x,y) according to the feature response step of FIG. 2.

### DETAILED DESCRIPTION OF THE PREFERRED EMBODIMENTS

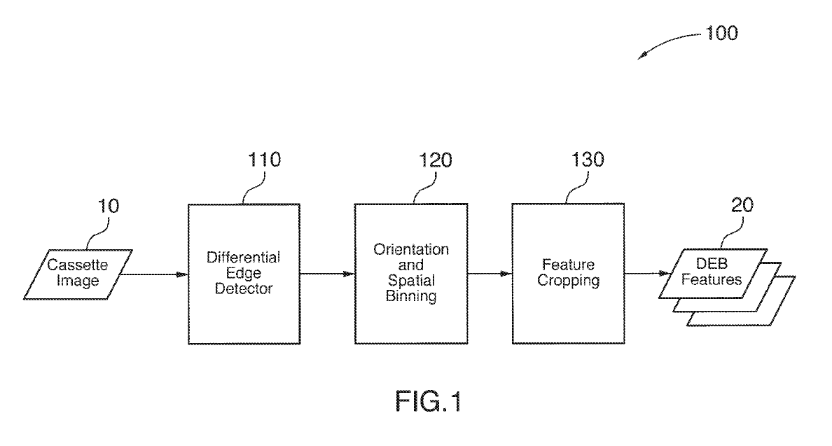

Referring now to FIGS. 1 through 9, there is shown a system, method and computer readable medium for discrete edge binning (or “DEB”) template matching according to a preferred embodiment of the present invention.

One or more DEB transforms (which may preferably result in one or more DEB features) preferably forms the basis for a feature extraction front end, preferably in an image registration system, method and/or computer readable medium according to the invention. FIG. 1 depicts steps of a DEB feature extraction method 100 according to a preferred embodiment of the invention. It may be appreciated that, according to the method 100, an input is preferably a normalized and/or cropped cassette image 10. In addition, an output is preferably a set of DEB features 20.

As shown in FIG. 1, the method 100 preferably includes the following steps, performed and/or provided by a system, method and/or computer readable medium according to the invention, among others: a differential edge detector step 110; an orientation and spatial binning step 110; and a feature cropping step 130.

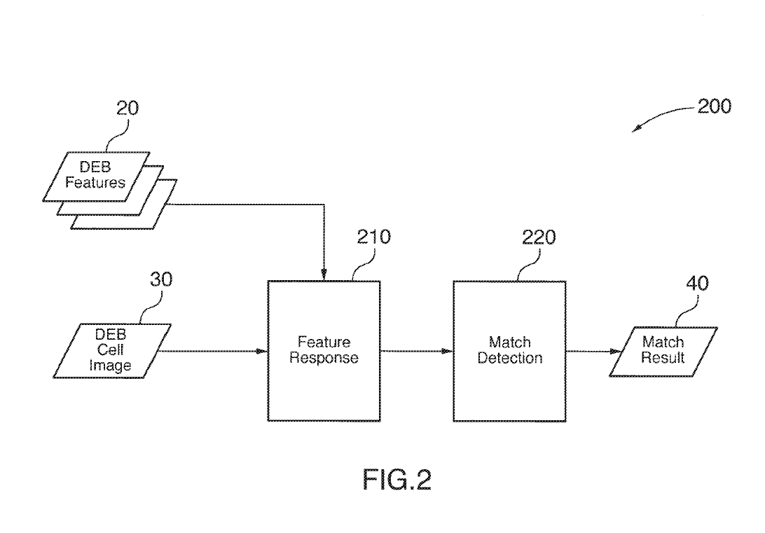

According to the present invention, DEB features classification are preferably a second phase of DEB template matching performed and provided by a system, method and/or computer readable medium, for comparing a set of reference features (preferably obtained during feature extraction) to an image to be classified, preferably in order to determine if the features match. FIG. 2 shows a flow of a DEB features classification method 200 preferably including the following steps, performed and provided by a system, method and/or computer readable medium according to the invention, among others: a feature response step 210; and a match detection step 220.

As shown in FIG. 2, the feature response step 210 preferably involves the comparison of DEB reference features (preferably stored in a database) to an input DEB cell image 30 and DEB features 20 (preferably generated from the DEB feature extraction method 100) to produce a feature response map representing how well the DEB features 20 match the DEB reference features.

For the match detection step 220, the location and correlation of best match is preferably compared to one or more internal thresholds, preferably to determine if a match is found (i.e., a match result 40) based on the comparison of the DEB features 20 with the DEB cell image 30.

The method 100 preferably provides for the achievement of contrast invariance by using a differential edge detector front end (i.e., substep 110 in FIG. 1), preferably in order to suppress all but the strongest responses for a given edge. Persons having ordinary skill in the art may appreciate that prior art template matching approaches may not have used a discrete edge template.

The method 100 also preferably provides for the achievement of selectable regional invariance by defining templates using a binned orientation and spatial approach—e.g., similar to those used by image registration algorithms of the prior art such as HOG and SIFT. Whereas prior art image registration algorithms may have defined feature descriptors over a small area, the present invention preferably combines feature cells into DEB templates. The DEB templates are preferably defined in such a manner that only the salient features are preferably selected—preferably provided that selectable regional invariance to areas in the image or within the template itself may be highly variable.

### A. DEB Feature Extraction

### Differential Edge Detector

According to the present invention, the differential edge detector step 110 preferably extracts a salient edge of a cassette image 10, preferably using contrast invariant techniques to provide contrast invariance (as shown in FIG. 1).

According to an aspect of one preferred embodiment of the invention, and as best seen in FIG. 1, a first step in the DEB feature extraction method (alternately referred to as a DEB transform) 100 performed and provided by a system, method and/or computer readable medium preferably applies a differential edge detector step 110, preferably to extract contrast invariant edges.

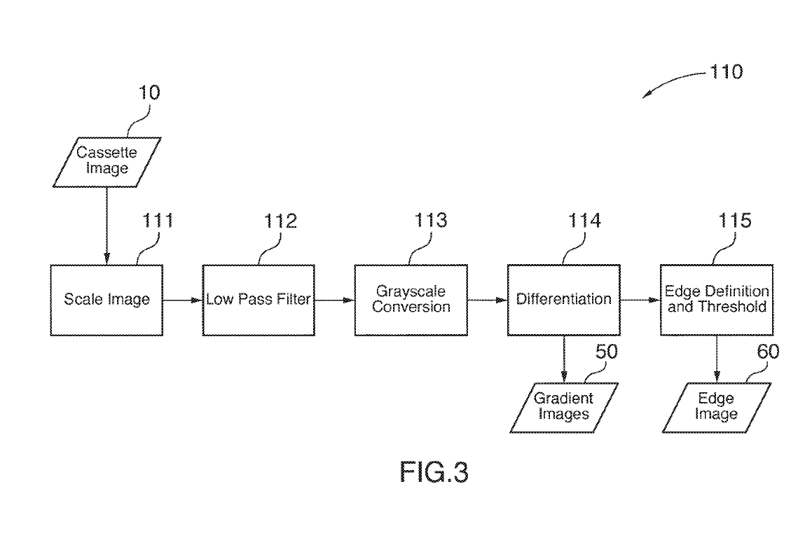

FIG. 3 depicts the step 110 in greater detail, the step 110 preferably including the following additional substeps, among others: a scale image substep 111; a low pass filter substep 112; a grey scale conversion substep 113; a differentiation substep 114; and an edge definition and threshold substep 115. The proposed step 110 preferably addresses shortcomings of other edge detectors in the prior art, such as the Sobel edge detector, preferably by allowing for contrast invariance.

In the sections below, one or more steps of the differential edge detector substep 110 as preferably performed by a system, method and/or computer readable medium according to one aspect of the invention are described in more detail.

### I. Scale Image

As shown in FIG. 3, according to the invention, in the scale image substep 111, the input cassette image 10 is preferably scaled to improve performance and to suppress artifacts with lower spatial resolution than desired. The scale size (“S”) is preferably application specific.

### II. Low Pass Filter

According to the invention, the low pass filter substep 112 depicted in FIG. 3 preferably involves the application of a Gaussian filter to the input cassette image 10, preferably in order to suppress high frequencies associated with pixel noise. This filter substep 112 combined with the aforementioned scaling substep 111 preferably makes up a simple scale space algorithm. The filter coefficient (“F”) is preferably application specific.

The low pass filter substep 112 preferably reduces high frequency noise by the application of a multivariate Gaussian filter to the input image 10. According to an aspect of one preferred embodiment of the invention, a covariance between x and y may preferably be assumed to be zero and the filter is preferably described according to the equation

$$F = \frac{1}{2 {πσ}_{x} {σ}_{y}} {e}^{( \frac{1}{2} [ \frac{{( x - {μ}_{x} )}^{2}}{{σ}_{x}^{2}} + \frac{{( y - {μ}_{y} )}^{2}}{{σ}_{y}^{2}} ) ]}$$

where F is the filter coefficient described above.

The filter is preferably convolved with the input image I, preferably to produce the filtered output I_{f} according to the equation

I_{f}=I*F

where F is the filter coefficient, as above.

### III. Grayscale Conversion

As shown in FIG. 3, the grayscale conversion substep 113 according to the invention is preferably used to convert the image 10 to grayscale, preferably for simpler processing. Persons having ordinary skill in the art may appreciate that a grayscale digital image is an image composed exclusively of shades of gray, varying from black at the weakest intensity to white at the strongest.

### IV. Differentiation

The differentiation substep 114 shown in FIG. 3, according to the invention, preferably includes the calculation of several first, second and/or third derivatives of the image 10 to produce one or more gradient images 50.

V. Differential Edge Definition and/or Threshold

According to the invention, the edge definition and threshold substep 115 shown in FIG. 3 preferably includes the adoption of a differential geometric definition of edges which preferably uses non-maximal suppression, preferably to localize each edge to a single pixel. The derivative images from the previous substep 114 are preferably used to estimate the geometrical edge. A single threshold (T) is preferably applied, above which the edge is preferably assumed to be significant. The threshold (T) is preferably application specific.

The edge definition and threshold substep 115 preferably involves the construction of an edge pixel defined as a point at which a gradient magnitude assumes a maximum in a direction of the gradient [see, for example, J. Canny, “A Computational Approach to Edge Detection”, IEEE Transactions on Pattern Analysis and Machine Intelligence, Vol. PAMI-8, No. 6, November 1986].

According to the invention, the gradient is preferably calculated by differentiating the filtered image along the x and y dimensions according to the equations

$${I}_{x} = \frac{\partial }{\partial x} {I}_{f}$$

$${I}_{y} = \frac{\partial }{\partial y} {I}_{f}$$

where I_{f} is the filtered output from above.

According to the invention, the direction of the gradient is preferably obtained according to the equation

$$θ = {cos}^{- 1} \frac{{I}_{x}}{\sqrt{{I}_{x}^{2} + {I}_{y}^{2}}}$$

based on the results from differentiating the filtered image along the x and y dimensions above.

Each point (or edge pixel) is preferably modified with a local coordinate transform, preferably such that new coordinates (u,v) are aligned to the direction of the gradient. Coordinate v is preferably parallel to the direction of the gradient, θ and coordinate u is preferably perpendicular to the direction of the gradient, θ. Preferably, with this coordinate transform, Iᵥ is preferably defined as the gradient at each point, preferably in the direction of the gradient. Iᵥ preferably has a magnitude equal to \sqrt{Iₓ²+I_{y}²} and/or an angle of θ. Using the definition above, it may be clear to persons having ordinary skill in the art that I(i,j) is preferably an edge pixel in accordance with the following equations

Iᵥᵥ=0

Iᵥᵥᵥ<0.

According to the invention, the first condition (Iᵥᵥ=0), above, preferably defines a condition when the gradient reaches a minimum or maximum value, preferably since a first derivative of the gradient may be equal to zero. According to the invention, the second condition (Iᵥᵥᵥ<0), above, preferably requires that that point be a maximum, preferably such that a second derivative of the gradient is negative, preferably corresponding to a concave curvature of the peak.

It is preferably shown that Iᵥᵥ and/or Iᵥᵥᵥ, according to the invention, are given by the following expressions [see, for example, T. Lindberg, “Edge Detection and Ridge Detection with Automatic Scale Selection”, International Journal of Computer Vision 30 (2): 117-154, 1998]

Iᵥᵥ=iₓ²Iₓₓ+2IₓI_{y}I_{xy}+I_{y}²I_{yy}

Iᵥᵥᵥ=Iₓ³Iₓₓₓ+3Iₓ²I_{y}I_{xxy}+3IₓI_{y}²I_{xyy}+I_{y}³I_{yyy}.

The foregoing definitions, as provided, preferably return all edges in a given image. Preferably, given that it still may be desirable to provide relatively strong edges, the second condition is preferably modified in accordance with the following relationship

Iᵥᵥᵥ<−T

where T is preferably a minimum threshold which preferably sets a minimum curvature of the edge point to be considered an edge.

### VI. Differential Edge Detector Output

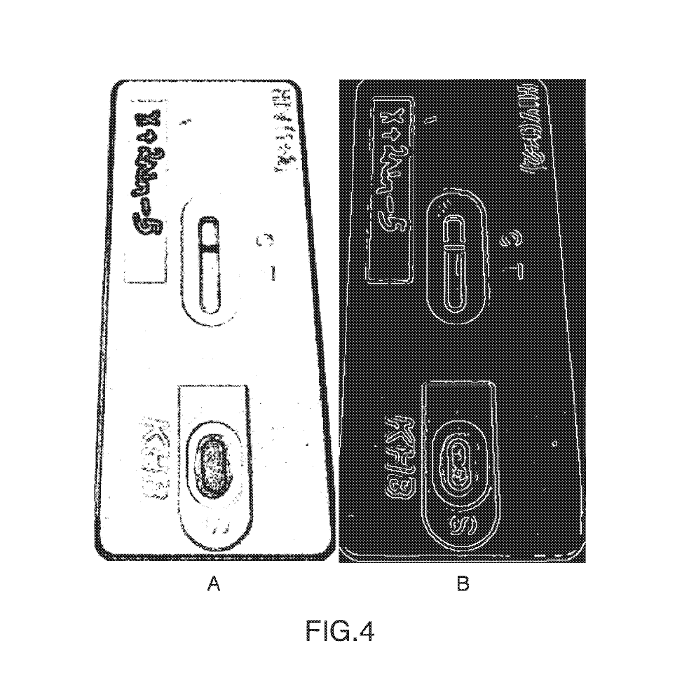

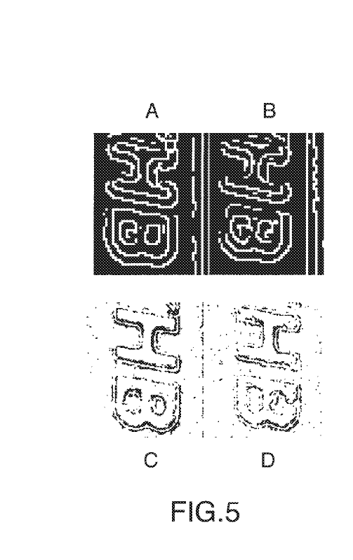

According to the invention, an output of the differential edge detector substep 115—the edge image 60—is preferably seen in FIGS. 4 and 5, which compare images from the prior art Sobel edge detector and the Differential Edge technique of the present invention. FIG. 4a depicts the image from the Sobel edge detector and FIG. 4b shows the image from the Differential Edge technique of the present invention according to one aspect of the invention. From these images (FIGS. 4a and 4b), it may be evident to persons having ordinary skill in the art that the Differential Edge technique (FIG. 4b) of the present invention preferably provides an image having greatly reduced noise and edges that are preferably all a single pixel thick regardless of the thickness of the edges of the input image 10 (e.g., compare the RDT edges to the interior features of FIG. 4b).

FIGS. 5a,b and FIGS. 5c,d depict enlarged views of the same localized region in FIGS. 4b and 4a respectively (i.e., the “FIB” letter region). FIGS. 5c,d show images of the “FIB” letter region (using the Sobel edge detector) having a high contrast and a low contrast, respectively, by varying the ambient lighting conditions during image capture. FIGS. 5a,b show images of the “FIB” letter region (using the differential edge technique of the present invention) having a high contrast and a low contrast, respectively, by varying the ambient lighting conditions during image capture. Persons having ordinary skill in the art may appreciate that FIGS. 5c and 5d show that the prior art Sobel edge detector technique produce images that may be sensitive to lighting conditions or contrast (i.e., not contrast invariant), whereas the differential edge technique (as shown in FIGS. 5a and 5b) according to one aspect of the invention are preferably much less sensitive to lighting conditions or contrast differences (i.e., contrast invariant).

Orientation and/or Spatial Binning

According to the present invention, in the orientation and spatial binning step 120 of the DEB feature extraction method 100 shown in FIG. 1, each edge pixel is preferably binned into 1 of N orientation bins and (preferably subsequently) binned spatially, preferably into an M×M cell, and preferably resulting in a DEB cell image 30 providing high sensitivity and selectable regional invariance.

This step 120 preferably involves the binning of the orientation of edges and the spatial location of edges. One purpose of this step 120 is preferably to provide higher specificity in edges, preferably by using the orientation of the edges to discriminate between shapes, and tolerance to edge location, preferably by allowing binning along the spatial dimension.

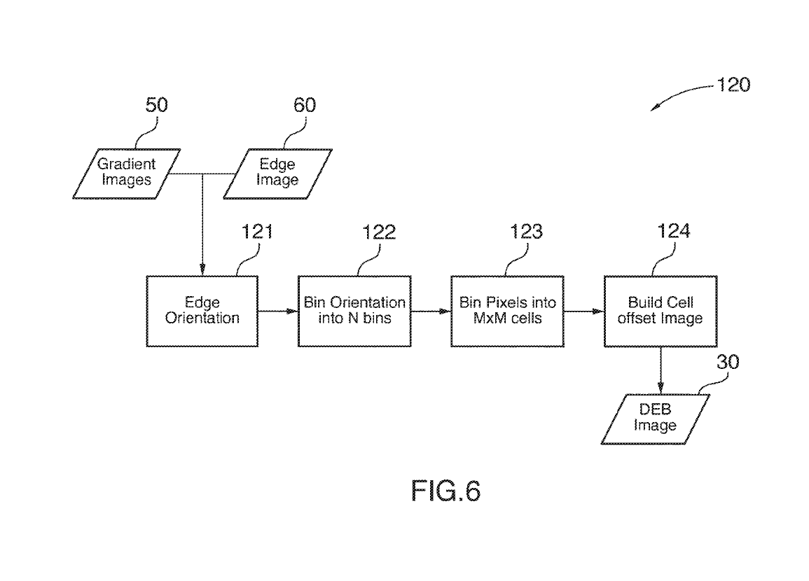

As shown in FIG. 6, there is depicted one or more substeps that are preferably performed and provided by a system, method and/or computer readable medium of the present invention, among others: an edge orientation substep 121; an orientation binning substep 122; a spatial binning substep 123; and a cell offset image substep 124.

### I. Edge Orientation

According to the present invention, the edge orientation substep 121 is preferably used to estimate an orientation of each pixel in the gradient image 50 and the edge image 60.

The orientation of the edge is preferably obtained using the first derivatives derived in the differentiation substep 114. The angle and magnitude of each edge pixel is preferably obtained using one or more of the following equations

$$θ = {cos}^{- 1} \frac{{I}_{x}}{\sqrt{{I}_{x}^{2} + {I}_{y}^{2}}}$$

$$r = \sqrt{{I}_{x}^{2} + {I}_{y}^{2}} .$$

According to the present invention, it may be desirable to be concerned only with the orientation. The formulae above are preferably used to generate an orientation image I_{θ}.

### II. Orientation Binning

According to the present invention, for the orientation binning substep 122, the orientation for each edge pixel is preferably binned into one of N bins representing the orientation between 0 and 180 degrees. The number of bins (N) is preferably application specific. Each pixel is preferably represented by a vector of length N, preferably where the vector is zero for all elements except the bin corresponding to the orientation of that pixel.

Preferably, for the orientation binning substep 122, a range from −90 to +90 degrees is divided into N segments. Since a significant number of features may be located on the vertical or horizontal directions, the bins are preferably defined such that they are centered around 0 degrees. Preferably by doing this or ensuring N is even, the vertical and horizontal edges are preferably positioned in the center of their respective bins. Using this definition, each edge pixel from the edge image, I_{E}, is preferably compared to the range and assigned to one of N bins. The assignment preferably occurs by defining a vector of length N for each pixel. The vector is preferably 0 for all elements, preferably except the element corresponding to the current edge orientation. That element is preferably set to unity. For example, if N=4, a pixel on a vertical line may correspond to

v=(0,1,0,0)

and, for a horizontal line, may correspond to

v=(0,0,0,1).

### III. Spatial Binning

According to the present invention, the spatial binning substep 123 preferably involves the binning of adjacent pixels into M×M cells and the orientation vectors are preferably summed.

This substep 123 is preferably performed on the output of the orientation binning substep 122, preferably to generate a cell output. Cells are preferably defined as a summed response of the pixels in an M×M area. A formula is preferably provided as follows

C(i,j)=Σk₌ᵢ^{i+M}Σₗ₌ⱼ^{j+M}v(k,l).

According to an aspect of one preferred embodiment of the invention, a result is preferably that each cell preferably contains a histogram of the orientations of the surrounding M×M pixels.

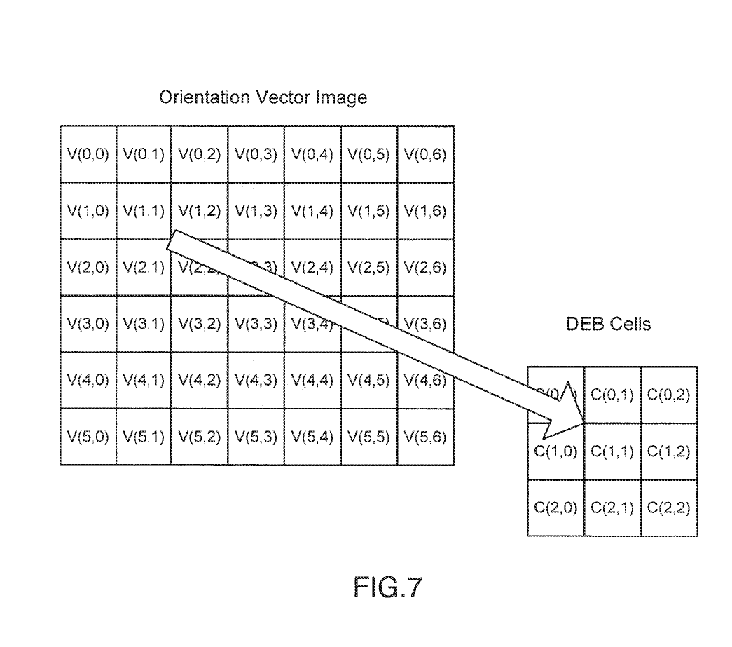

FIG. 7 depicts an example of spatial binning for a 4×4 pixel area, whereby a 4×4 area in the orientation vector image defined by pixels v(1,1), v(1,4), v(4,1) and v(4,4) is placed into bin C(1,1) of the DEB cells, whose coordinates correspond to pixel v(1,1). Similarly, while not shown in FIG. 7, a 4×4 area in the orientation vector image defined by pixels v(1,2), v(1,5), v(4,2) and v(4,5) would be placed into bin C(1,2) of the DEB cells to correspond with pixel v(1,2). In this manner, adjacent pixels within a defined area of an image may be binned. Persons having ordinary skill in the art will understand that the 4×4 pixel area is preferably for the purpose of illustration and that pixel areas of any size may be used in accordance with the present invention.

### IV. Cell Offset Image

According to the present invention, the cell offset image substep 124 preferably involves the processing of the resulting image from the binning substeps 122,123 to generate a cell offset image, preferably containing M×M scaled images corresponding to the starting offset of the cell. This is preferably done to ensure overlap in features when binning the pixels into M×M cells.

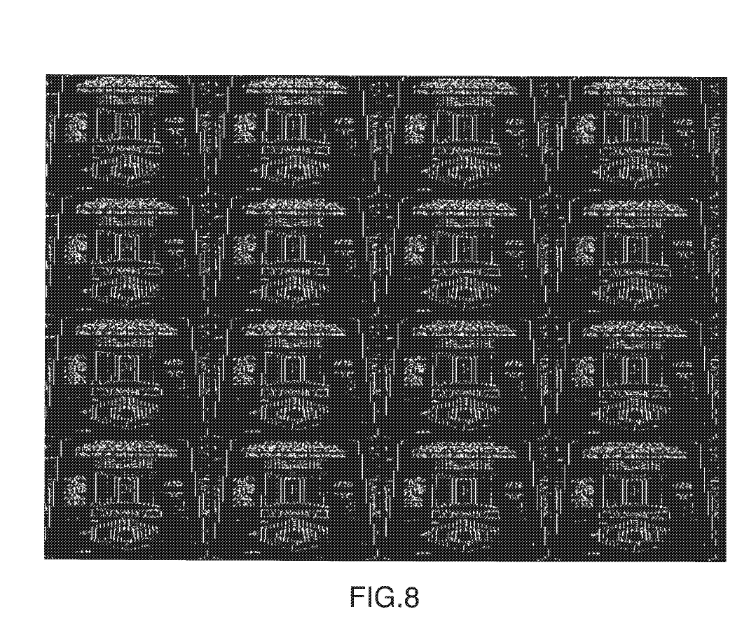

According to the present invention, the output of the spatial binning substep 123 is preferably further processed, preferably to generate a DEB cell offset image (I_{DEB}) 30. This substep 123 is preferably an optimization substep, which preferably facilitates feature classification and matching. The offset image 30 is preferably created by reorganizing the cells, preferably such that the cells are located relative to the initial offset. According to one aspect of the invention, the offset is preferably the distance in pixels from the origin to the starting location of the first cells in the M×M region. For example, for cell(0,0) the offset may be (0,0), whereas for cell(1,4) the offset may be (1,4) based on 4×4 spatial binning. Preferably by reorganizing the cells, the resulting DEB image 30 is similar to the image depicted in FIG. 8, in this case for 4×4 spatial binning.

FIG. 8 shows an example of the DEB image 30 after reorganizing for the cell offset. In view of the disclosure herein, it should be appreciated by persons having ordinary skill in the art that FIG. 8 depicts sixteen (4×4) scaled images, with each image corresponding to a different starting offset of the spatial binning substep 123.

### Feature Cropping

According to the present invention, in the feature cropping step 130 as shown in the method 100 of FIG. 1, salient features of the DEB cell image 30 are preferably cropped according to requirements and/or stored for later classification against other images.

The feature cropping step 130 may preferably identify and crop selected salient features, which are preferably used for matching. This is preferably achieved by selecting a block of pixels from the DEB cell image 30, F. One or more of the following constraints is preferably used in the feature cropping step 130: (i) the starting column is preferably a multiple of the number of orientation bins (N); and/or (ii) the ending column is preferably a multiple of the number of orientation bins (N).

### B. Feature Classification

As best shown in FIG. 2, the feature classification method 200 is preferably used to compare DEB reference features (preferably from a database), preferably against an input DEB image (which may comprise DEB features 20 and DEB cell image 30) and/or preferably in order to locate and match the DEB features 20 within the image 30 with the DEB reference features. One or more steps according to one aspect of the invention are preferably detailed below.

### Feature Response

According to the DEB feature classification method 200 shown in FIG. 2, an aspect of the present invention is preferably to calculate the feature response 210 by performing a cross correlation of the DEB feature 20 preferably with the input DEB cell image 30. The cross correlation of the feature response step 210 is preferably normalized by the feature squared sum, preferably in order to generate a normalized match value in accordance with the following equations

$$C ( x , y ) = {\sum }_{i = 0}^{M - 1} {\sum }_{j = 0}^{N - 1} I ( i , j ) F ( i - x , j - y )$$

$$R ( x , y ) = \frac{R ( x , y )}{{Σ}_{i = 0}^{P - 1} {Σ}_{j = 0}^{Q - 1} T ( i , j )}$$

where I(I,j) is preferably an input DEB cell image 30 of size (M,N) and T(i,j) is preferably a DEB feature 20 of size (P,Q) being evaluated. Here C(x,y) is preferably the correlation and R(x,y) is preferably the normalized response.

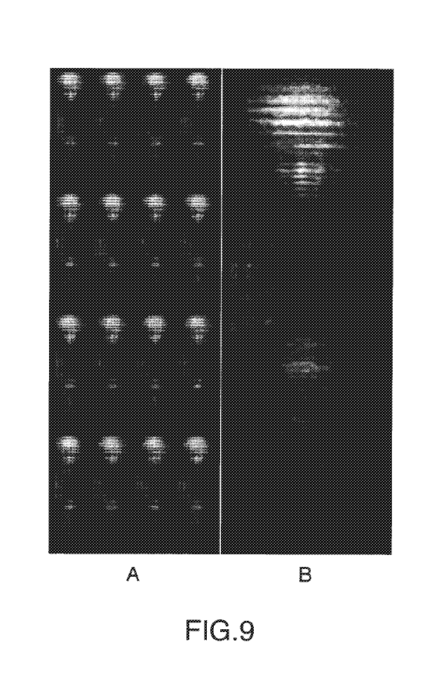

According to the present invention, and preferably in order to facilitate localization of the optimal match, the response image is preferably reorganized to produce a match response image M(x,y). The original response, R(x,y)—similar to the DEB cell image 30—preferably contains M×M sub-images corresponding to the response for each cell offset. This image is preferably reorganized, preferably such that a single image is visible. For example, FIGS. 9a and 9b depict an original response image and a reorganized match response image, respectively. The brighter areas in FIGS. 9a,b may preferably correspond to regions where a higher match for a DEB feature preferably has been calculated.

### Match Detection

According to the present invention, the match detection step 220, as shown in FIG. 2, preferably locates a position in an image (e.g., a reorganized match response image) where a match may be detected and/or determine if a DEB feature match is found. Preferably, an application specific DEB template (e.g., a DEB template for a specific RDT or test for a biomarker), preferably containing DEB reference features, is retrieved from a database and used in the match detection step 220. Match detection 220 is preferably achieved by defining one or more of the following configuration parameters for each DEB template: (i) search origin, which may preferably be an indication of the location of an upper left corner of the feature (e.g., preferably where to search for the DEB feature in the image); (ii) search tolerance, which may be pixel tolerance (e.g., preferably indicating a size of a search area); (iii) correlation threshold, which may preferably be a minimum correlation value for a match result; and (iv) distance threshold, which may preferably be a maximum distance of match from the search origin.

The match detection step 220 preferably includes a search of a defined search area of an image, using the DEB template containing DEB reference features, for a response peak. Preferably, if the response peak exceeds the correlation threshold or the distance to the search origin is less than the distance threshold, then a match is preferably found, producing a match result 40. Persons having ordinary skill in the art may understand that a match result 40 for an RDT may, for example, indicate the presence of absence of a specific disease state or biomarker.

### CONCLUSION

The present invention is contemplated for use in association with image processing algorithms and template matching to detect and localize similar features within an image, and/or in association with recognition of RDTs based on their appearance, to afford increased functionality and/or advantageous utilities in association with same. The invention, however, is not so limited.

The foregoing description has been presented for the purpose of illustration and is not intended to be exhaustive or to limit the invention to the precise form disclosed. Other advantages, features and/or characteristics of the present invention, as well as methods of operation and/or functions of the related elements of the system, method and/or computer readable medium, and/or the combination of steps, parts and/or economies of manufacture, will become more apparent upon consideration of the accompanying drawings. Certain novel features which are believed to be characteristic of the system, method and/or computer readable medium according to the present invention, as to their organization, use, and/or method of operation, together with further objectives and/or advantages thereof, will be better understood from the accompanying drawings in which presently preferred embodiments of the invention are illustrated by way of example. It is expressly understood, however, that the drawings are for the purpose of illustration and description only, and are not intended as a definition of the limits of the invention.

Naturally, in view of the teachings and disclosures herein, persons having ordinary skill in the art may appreciate that alternate designs and/or embodiments of the invention may be possible (e.g., with substitution of one or more components, features, steps, algorithms, etc. for others, with alternate configurations of components, features, steps, algorithms, etc). Although some of the components, features, steps, algorithms, relations and/or configurations according to the invention are not specifically referenced in association with one another, they may be used, and/or adapted for use, in association therewith. All of the aforementioned, depicted and various structures, configurations, features, steps, algorithms, relationships, utilities and the like may be, but are not necessarily, incorporated into and/or achieved by the invention. Any one or more of the aforementioned structures, configurations, features, steps, algorithms, relationships, utilities and the like may be implemented in and/or by the invention, on their own, and/or without reference, regard or likewise implementation of any of the other aforementioned structures, configurations, features, steps, algorithms, relationships, utilities and the like, in various permutations and combinations, as will be readily apparent to those skilled in the art, without departing from the pith, marrow, and spirit of the disclosed invention.

This concludes the description of presently preferred embodiments of the invention. The foregoing description has been presented for the purpose of illustration and is not intended to be exhaustive or to limit the invention to the precise form disclosed. Other modifications, variations and alterations are possible in light of the above teaching and will be apparent to those skilled in the art, and may be used in the design and manufacture of other embodiments according to the present invention without departing from the spirit and scope of the invention. It is intended the scope of the invention be limited not by this description but only be the claims forming a part hereof

What is claimed is:

1. A method of matching at least part of an image against one or more reference templates stored in a database, wherein at least one edge feature is embedded in the image, wherein the method comprises:
a) a database providing step of providing the database, such that each of the reference templates comprises a set of reference feature parameters;
b) a receiving step of receiving the image;
c) a feature extraction step comprising:
i) a differential edge detection substep of using a contrast invariant technique to render the image contrast invariant and to depict one or more edge pixels of the edge feature among one or more image pixels of the image; and
ii) an orientation and spatial binning substep of binning the edge pixels into a predetermined number of orientation bins, and spatially binning adjacent ones of the image pixels into discrete edge binning (DEB) cells, to generate a DEB cell image depicting the edge feature; and
d) a feature classification step comprising:
i) a feature response substep of comparing the DEB cell image to each said set of reference feature parameters to determine how well the DEB cell image matches each of the reference templates; and
ii) a match detection substep of locating a best match of the DEB cell image among the reference templates, and correlating the best match against one or more predetermined match threshold values to determine when a matching one of the reference templates is found;
whereby the image is matched with the matching one of the reference templates.

2. The method according to claim 1, wherein a first one of the reference templates is provided with higher sensitivity, than a second one of the reference templates, to the edge feature embedded in the image and depicted in the DEB cell image.

3. The method according to claim 1, wherein a first one of the reference templates matches a different region of the image than a second one of the reference templates.

4. The method according to any one of claims 1 to 3 wherein, in the differential edge detection substep, the image is scaled and any artifacts in the image with spatial resolution lower than a predetermined spatial resolution threshold value are suppressed.

5. The method according to any one of claims 1 to 4 wherein, in the differential edge detection substep, a low pass filter is applied to and convolved with the image to suppress high frequencies associated with pixel noise.

6. The method according to claim 5, wherein the low pass filter is a multivariate Gaussian filter.

7. The method according to any one of claims 1 to 6 wherein, in the differential edge detection substep, the image is converted to greyscale.

8. The method according to any one of claims 1 to 7 wherein, in the differential edge detection substep, one or more derivatives of the image are differentially calculated and used to localize and geometrically define the edge feature.

9. The method according to claim 8 wherein, in the differential edge detection substep, the derivatives comprise a gradient calculated by differentiating the image in two dimensions, and a direction of the gradient is obtained and used to localize and geometrically define the edge pixels of the edge feature at a gradient maximum along the direction of the gradient.

10. The method according to one of claims 8 and 9, wherein the derivatives are used, with reference to a predetermined edge minimum threshold value, to define the edge feature.

11. The method according to any one of claims 1 to 7 wherein, in the differential edge detection substep, one or more derivatives of the image are differentially calculated; and wherein the derivatives are used to calculate an orientation for each of the edge pixels.

12. The method according to claim 11 wherein, in the orientation and spatial binning substep, the orientation for each of the edge pixels is assigned to one of the predetermined number of orientation bins most closely corresponding to the orientation.

13. The method according to claim 12 wherein, in the orientation and spatial binning substep, for each one of the discrete edge binning (DEB) cells, a sum is calculated based on the orientation bin assigned to each of the edge pixels among the image pixels spatially binned into said each one of the discrete edge binning (DEB) cells.

14. The method according to any one of claims 1 to 12 wherein, in the orientation and spatial binning substep, for each one of the discrete edge binning (DEB) cells, a sum is calculated based on the orientation for each of the edge pixels among the image pixels spatially binned into said each one of the discrete edge binning (DEB) cells.

15. The method according to any one of claims 1 to 14 wherein, in the orientation and spatial binning substep, each of the discrete edge binning (DEB) cells correlates to a substantially rectangular (M₁×M₂) configuration of said adjacent ones of the image pixels.

16. The method according to claim 15 wherein, in the orientation and spatial binning substep, the image is processed to generate a cell offset image containing (M₁×M₂) scaled images corresponding to a starting offset of said each of the discrete edge binning (DEB) cells.

17. The method according to any one of claims 1 to 16, wherein the feature extraction step further comprises a feature cropping substep of cropping the DEB cell image to normalize depiction of the edge feature in the DEB cell image.

18. The method according to any one of claims 1 to 17, wherein in the feature response substep, for each of the reference templates, a match value is calculated against the DEB cell image.

19. The method according to any one of claims 1 to 18, wherein in the feature response substep, one or more feature response maps are generated representing how well the DEB cell image matches each of the reference templates.

20. The method according to claim 19 wherein, in the match detection substep, the best match is located on the feature response maps.

21. The method according to any one of claims 1 to 20, wherein the predetermined match threshold values comprise: a predetermined correlation threshold value based on a correlation with the edge feature; and/or a predetermined distance threshold value based on a distance from a search origin for the edge feature.

22. The method according to any one of claims 1 to 21, adapted for use with a rapid diagnostic test device and/or cassette image as the image.

23. A system for matching at least part of an image, wherein at least one edge feature is embedded in the image, wherein the system comprises:
a) a database which stores one or more reference templates, with each of the reference templates comprising a set of reference feature parameters;
b) an image receiving element operatively receiving the image;
c) one or more image processors operative to match said at least part of the image against the reference templates stored in the database, with the image processors operatively encoded to:
i) use a contrast invariant technique to render the image contrast invariant and depict one or more edge pixels of the edge feature among one or more image pixels of the image;
ii) bin the edge pixels into a predetermined number of orientation bins, and spatially bin adjacent ones of the image pixels into discrete edge binning (DEB) cells, to generate a DEB cell image depicting the edge feature;
iii) compare the DEB cell image to each said set of reference feature parameters to determine how well the DEB cell image matches each of the reference templates; and
iv) locate a best match of the DEB cell image among the reference templates, and correlating the best match against one or more predetermined match threshold values to determine when a matching one of the reference templates is found;
whereby the system matches the image with the matching one of the reference templates.

24. The system according to claim 23, wherein a first one of the reference templates has higher sensitivity, than a second one of the reference templates, to the edge feature embedded in the image and depicted in the DEB cell image.

25. The system according to claim 23, wherein a first one of the reference templates matches a different region of the image than a second one of the reference templates.

26. The system according to any one of claims 23 to 25 wherein the image processors are also operatively encoded to scale the image and suppress any artifacts in the image with spatial resolution lower than a predetermined spatial resolution threshold value.

27. The system according to any one of claims 23 to 26 further comprising a low pass filter; and wherein the image processors are also operatively encoded to apply the low pass filter to, and convolve the low pass filter with, the image to suppress high frequencies associated with pixel noise.

28. The system according to claim 27, wherein the low pass filter is a multivariate Gaussian filter.

29. The system according to any one of claims 23 to 28, wherein the image processors are also operatively encoded to convert the image to greyscale.

30. The system according to any one of claims 22 to 29, wherein the image processors are also operatively encoded to differentially calculate one or more derivatives of the image and to use the derivatives to localize and geometrically define the edge feature.

31. The system according to claim 30, wherein the image processors are also operatively encoded: to calculate one or more of the derivatives as a gradient by differentiating the image in two dimensions; to obtain a direction of the gradient; and to use the direction of the gradient to localize and geometrically define the edge pixels of the edge feature at a gradient maximum along the direction of the gradient.

32. The system according to one of claims 30 and 31, wherein the image processors are also operatively encoded to use the derivatives, with reference to a predetermined edge minimum threshold value, to define the edge feature.

33. The system according to any one of claims 23 to 29, wherein the image processors are also operatively encoded: to differentially calculate one or more derivatives of the image; and to use the derivatives to calculate an orientation for each of the edge pixels.

34. The system according to claim 33, wherein the image processors are also operatively encoded to assign the orientation for each of the edge pixels to one of the predetermined number of orientation bins most closely corresponding to the orientation.

35. The system according to claim 34, wherein the image processors are also operatively encoded to, for each one of the discrete edge binning (DEB) cells, calculate a sum based on the orientation bin assigned to each of the edge pixels among the image pixels spatially binned into said each one of the discrete edge binning (DEB) cells.

36. The system according to any one of claims 23 to 34, wherein the image processors are also operatively encoded to, for each one of the discrete edge binning (DEB) cells, calculate a sum based on the orientation for each of the edge pixels among the image pixels spatially binned into said each one of the discrete edge binning (DEB) cells.

37. The system according to any one of claims 23 to 36, wherein the image processors are also operatively encoded to correlate each of the discrete edge binning (DEB) cells to a substantially rectangular (M₁×M₂) configuration of said adjacent ones of the image pixels.

38. The system according to claim 37, wherein the image processors are also operatively encoded to process the image to generate a cell offset image containing (M₁×M₂) scaled images corresponding to a starting offset of said each of the discrete edge binning (DEB) cells.

39. The system according to any one of claims 23 to 38, wherein the image processors are also operatively encoded to crop the DEB cell image to normalize depiction of the edge feature in the DEB cell image.

40. The system according to any one of claims 23 to 39, wherein the image processors are also operatively encoded to, for each of the reference templates, calculate a match value against the DEB cell image.

41. The system according to any one of claims 23 to 40, wherein the image processors are also operatively encoded to generate one or more feature response maps representing how well the DEB cell image matches each of the reference templates.

42. The system according to claim 41, wherein the image processors are also operatively encoded to locate the best match on the feature response maps.

43. The system according to any one of claims 23 to 42, wherein the predetermined match threshold values comprise: a predetermined correlation threshold value based on a correlation with the edge feature; and/or a predetermined distance threshold value based on a distance from a search origin for the edge feature.

44. The system according to any one of claims 23 to 43, adapted for use with a rapid diagnostic test device and/or cassette image as the image.

45. A computer readable medium for use with an image wherein at least one edge feature is embedded, and with a database which stores one or more reference templates that each comprise a set of reference feature parameters, the computer readable medium encoded with executable instructions to, when executed, encode one or more image processors to automatically match at least part of the image against the reference templates stored in the database by automatically performing the steps of:
a) using a contrast invariant technique to render the image contrast invariant and depict one or more edge pixels of the edge feature among one or more image pixels of the image;
b) binning the edge pixels into a predetermined number of orientation bins, and spatially binning adjacent ones of the image pixels into discrete edge binning (DEB) cells, to generate a DEB cell image depicting the edge feature;
c) comparing the DEB cell image to each said set of reference feature parameters to determine how well the DEB cell image matches each of the reference templates; and
d) locating a best match of the DEB cell image among the reference templates, and correlating the best match against one or more predetermined match threshold values to determine when a matching one of the reference templates is found;
whereby the computer readable medium encodes the image processors to match the image with the matching one of the reference templates.
